(19) United States
(12) Patent Application Publication
(10) Pub. No.: US 2024/0409717 A1
(43) Pub. Date: Dec. 12, 2024

(54) HOLLOW CARBON FIBERS AS MECHANICALLY ROBUST THERMAL INSULATING MATERIALS

(71) Applicant: University of Kentucky Research Foundation, Lexington, KY (US)

(72) Inventors: Matthew C. Weisenberger, Lawrenceburg, KY (US); Elizabeth Ashley Morris, Lexington, KY (US)

(21) Appl. No.: 18/737,578

(22) Filed: Jun. 7, 2024

Related U.S. Application Data
(60) Provisional application No. 63/472,231, filed on Jun. 9, 2023.

(51) Int. Cl. C08K 7/24

(52) U.S. Cl. CPC C08K 7/24; C08K 2201/003

(57) ABSTRACT

An insulating material includes hollow carbon fibers embedded in a matrix material. The insulating material is characterized by a unique combination of stiffness, strength, and insulating properties and has a modulus of elasticity of greater than 150 GPa, a tensile strength of greater than 1,200 MPa and a thermal conductivity of less than about 1 W/mK.

### RELATED APPLICATION

This application claims priority to U.S. Provisional Patent Application Ser. No. 63/472,231, filed on Jun. 9, 2023, the full disclosure of which is incorporated herein by reference.

### GOVERNMENT INTEREST

This invention was made with government support under grant number DE-EE0009241 awarded by the U.S. Department of Energy. The government has certain rights in the invention.

### TECHNICAL FIELD

This document relates to thermal insulating composite materials comprising hollow carbon fibers embedded in a matrix material, that are characterized by a unique combination of thermal insulating properties and mechanical strength, as well as to products made therefrom, including, but not necessarily limited to, composite tanks for cryogenic liquid storage.

### BACKGROUND

It is well known that fabricating thermally insulating materials with excellent thermal insulation performance together with high mechanical strength is a challenge. Hollow carbon fibers (HCF), developed from hollow polyacrylonitrile (PAN) precursors, have demonstrated mechanical robustness and also provide thermal insulation to composite materials. This combination of mechanical performance and thermal insulation makes these HCF a highly unique material.

To provide thermal insulation, the hollow portion (or lumen) of the HCF remains hollow when the fiber is embedded in a thermoset or thermoplastic polymer matrix to form a carbon fiber reinforced polymer (CFRP) composite. Traditional CFRP composites are known for their excellent strength, rigidity, and light weight. The trapped air (or other gases or materials, or vacuum, if used) within the lumen of the HCF is a poor thermal conductor and results in decreased through thickness thermal conductivity for the HCF composite, particularly when compared to traditional solid carbon fiber composites. A schematic illustrating this effect is shown in FIG. 1. This material has unique applications in a variety of thermal insulation areas, but one of particular interest is for the cryogenic storage of liquid hydrogen (LH2).

### SUMMARY

In accordance with the purposes and benefits set forth herein, a new and improved insulating material, comprises, consists of or consists essentially of hollow carbon fibers embedded in a matrix material. The insulating material is a carbon fiber reinforced polymer composite including about 60 wt % to about 90 wt % hollow carbon fiber and about 40 wt % to about 10 wt % matrix material.

The hollow carbon fiber may have an average filament open area of between about 20% to about 70%. Thus, in at least some embodiments, the hollow carbon fiber has a filament open area of at least 30%. In at least some embodiments, the hollow carbon fiber has a filament open area of at least 40%. In at least some embodiments, the hollow carbon fiber has a filament open area of at least 50%. In at least some embodiments, the hollow carbon fiber has a filament open area of at least 60%. In at least some embodiments, the hollow carbon fiber has a filament open area of at least 70%.

The hollow carbon fiber of the insulating material may have an average inner diameter of between about 3 microns to about 30 microns and an average outer diameter of between about 5 microns and about 50 microns. In some embodiments, the hollow carbon fiber has an average inner diameter of between about 4.5 microns to about 10 microns and an average outer diameter of between about 7 microns and about 25 microns.

The matrix material of the insulating material may be a thermosetting resin, a thermoplastic resin or mixtures thereof. The thermosetting resin may be selected from a group consisting of epoxy, melamine, phenolic, polyester, silicone, urea-based resin and combinations thereof. The thermoplastic resin may be selected from a group consisting of acetal, acrylic, cellulose acetate, nylon, polycarbonate, polyethylene, polypropylene and polystyrene based resins as well as combinations thereof.

In at least some of the many possible embodiments of the insulating material, the lumens of the hollow carbon fibers are sealed in a state of vacuum for enhanced insulation properties.

In accordance with an additional aspect, an insulating material is characterized by a unique combination of stiffness, strength, and insulating properties. More specifically, the insulating material may have a modulus of elasticity of greater than 150 GPa, a tensile strength of greater than 500 MPa (and preferably greater than 1,200 MPa), and a thermal conductivity of less than about 1 W/mK. The hollow carbon fibers of such a material may have an average inner diameter of between about 3 microns to about 30 microns and an average outer diameter of between about 5 microns and about 50 microns.

In accordance with yet another aspect, a composite tank, particularly suited for the storage of cryogenic liquids, may be made from insulating material, comprising, consisting of or consisting essentially of hollow carbon fibers embedded in a matrix material as set forth and described in this document. Still further, a composite storage tank may be made from an insulating material having a modulus of elasticity of greater than 150 GPa, a tensile strength of greater than 1,200 MPa and a thermal conductivity of less than about 1 W/mK.

In the following description, there are shown and described several different embodiments of the new and improved insulating material, and a composite made from this material. As it should be realized, the insulating material and composite made from the insulating material are capable of other, different embodiments and their several details are capable of modification in various, obvious aspects all without departing from the insulating material and composite as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate certain aspects of the new and improved insulating materials and together with the description serve to explain certain principles thereof. A person of ordinary skill in the art will readily recognize from the following discussion that alternative embodiments of the insulating materials may be employed without departing from the principles described below.

FIG. 1 is a schematic illustration of the improved thermal insulation performance of the insulating materials disclosed herein over traditional solid carbon fiber composites.

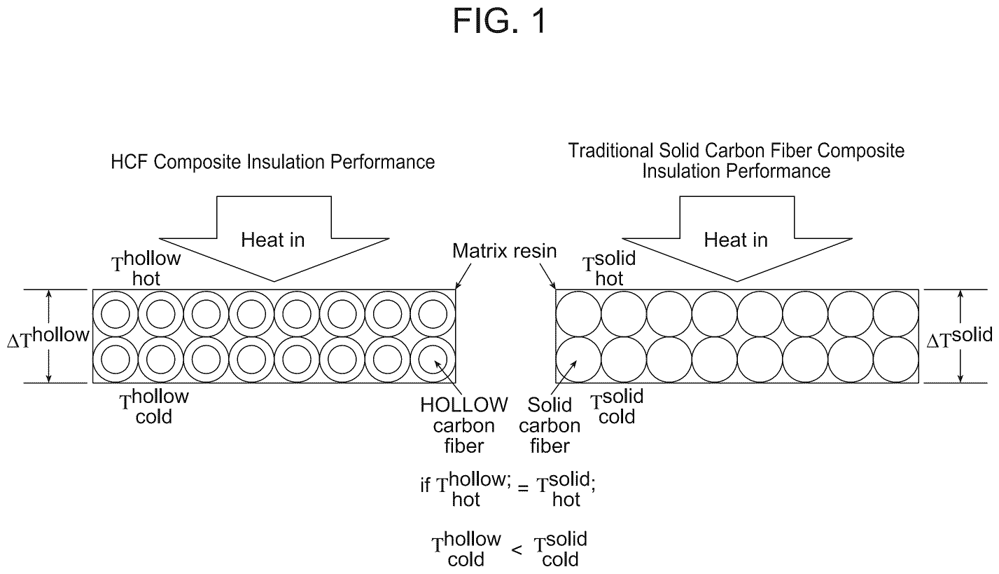

FIG. 2 is a schematic illustration of the new and improved insulating material made from hollow carbon fibers embedded in a matrix material.

Reference will now be made in detail to the present preferred embodiments of the apparatus and method.

### DETAILED DESCRIPTION

The production of hollow fibers in this application may utilize a multifilament, segmented arc spinneret (2C, 3C or similar) and a solution spinning approach. Other approaches that may be used for the production of hollow fibers include, but are not limited to, bi-component spinning, bore fluid spinning, or the use of a microfilm blowing spinneret, which is described in detail in published U.S. Patent Application No. 2023/0008772 to Weisenberger, the full disclosure of which is incorporated herein by reference. Hollow fibers may be solution spun, melt spun, or dry spun. Such hollow fibers may be converted to hollow carbon fibers by carbonization processes well known to those skilled in the art. Precursors for the hollow carbon fibers can be spun in tows from 25 to 3000 filaments and beyond.

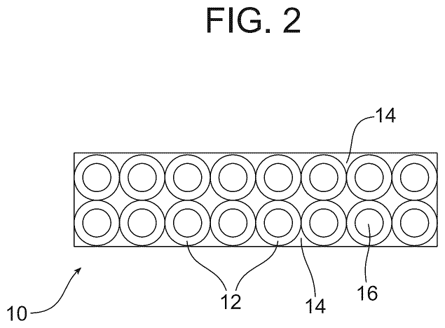

This document relates to a new and improved insulating material 10 that is characterized by a unique combination of stiffness, strength, and insulating properties. More specifically, the insulating material 10 has a modulus of elasticity of greater than 150 GPa, a tensile strength of greater than 1,200 MPa and a thermal conductivity of less than about 1 W/mK. The insulating material is a carbon fiber reinforced polymer composite including hollow carbon fibers 12 embedded in a matrix material 14. See FIG. 2.

The matrix material 14 may comprise a thermosetting resin, a thermoplastic resin or even a combination of thermoseting and thermoplastic resins. Thermosetting resins useful as the matrix material, include, but are not necessarily limited to, epoxy, melamine, phenolic, polyester, silicone and urea-based resins as well as combinations thereof. Thermoplastic resins useful as the matrix material 14 include, but are not necessarily limited to, acetal, acrylic, cellulose acetate, nylon, polycarbonate, polyethylene, polypropylene and polystyrene based resins as well as combinations thereof.

The insulating material 10 may include about 60 wt % to about 90 wt % hollow carbon fibers 12 and about 40 wt % to about 10 wt % matrix material 14. In some embodiments, the insulating material 10 may include about 70 wt % to about 80 wt % hollow carbon fibers 12 and about 30 wt % to about 20 wt % matrix material 14. In still other embodiments, the insulating material 10 may include about 75 wt % hollow carbon fibers 12 and about 25 wt % matrix material 14.

The hollow carbon fiber 12 may have an average filament open area of between about 20% to about 70%. In some embodiments, the hollow carbon fiber 12 has an average filament open area of at least 30%. In some embodiments, the hollow carbon fiber 12 has an average filament open area of at least 40%. In some embodiments, the hollow carbon fiber 12 has an average filament open area of at least 50%. In some embodiments, the hollow carbon fiber 12 has an average filament open area of at least 60%. In some embodiments, the hollow carbon fiber 12 has an average filament open area of at least 70%.

In some embodiments, the hollow carbon fiber 12 has an average inner diameter of between about 3 microns to about 30 microns and an average outer diameter of between about 5 microns and about 50 microns. In still other embodiments, the hollow carbon fiber 12 has an average inner diameter of between about 4.5 microns to about 10 microns and an average outer diameter of between about 7 microns and about 25 microns. The tubular wall of the hollow carbon fiber 12 generally has a thickness of between about 1 and about 20 microns.

The hollow carbon fibers 12 can be processed with the matrix material 14 into composites in the same way as solid fibers to produce the insulating material 10. Wet layout, prepreg lamination, and/or resin transfer molding may be used. In some particularly useful embodiments, the hollow carbon fibers 12 include sealed lumens 16 in vacuum. To apply vacuum to the interior or lumen of the fiber, the fiber ends should be exposed to the vacuum atmosphere (not coated in resin). Vacuum should be applied and maintained while resin is applied to the fiber ends to “seal” the vacuum in the fiber lumen.

Advantageously, as noted above, the insulating material 10 provides a very unique and beneficial combination of strength and thermal insulating properties making it useful in a number of important applications. For example, clean hydrogen deployment is a major focus of the U.S. Department of Energy (DOE), which has invested $400 million in hydrogen related research activities in 2022 alone (up from $285 million on 2021). There is significant interest in using LH2 to power fuel cell electric vehicles. These vehicles are more efficient than conventional internal combustion engine vehicles and produce no tailpipe emissions (emitting only water vapor and warm air).

Hydrogen has a low volumetric energy density, and as a result, is typically carried in compressed overwrapped pressure vessels. These pressure vessels must be rated to 700 bar for passenger vehicles. However, compressed hydrogen gas would struggle to meet the volumetric capacity and cost requirements for medium and heavy-duty vehicles. As such, liquid hydrogen (LH2) is utilized. The central challenge with onboard LH2 storage is dealing with the ultralow temperature of LH2, approximately −253° C. or 20 K, required to prevent boil off of the LH2. Therefore, thermally insulating materials 10 are essential to insulating the cryogenic LH2 from the surrounding environment.

One of the primary incumbent technologies for thermal insulation in these cryogenic pressure vessels are glass bubbles. These glass bubbles are embedded in a paste and provide excellent thermal insulation. However, these glass bubbles unfortunately possess very poor mechanical strength. For context, the tensile strength of the glass bubble in paste would be ˜1 MPa. In stark contrast, the thermal insulation material 10 disclosed in this document has a tensile strength≥1200 MPa. Thus, the thermal insulation material 10 disclosed in this document has a very significant strength advantage over state of the art materials used in the construction of tanks for cryogenic liquid storage.

Other technologies under study as thermal insulating materials include silica aerogels, hollow polymer fibers, and hollow fibers filled with cellulose aerogels. All have promising insulation properties, but very poor mechanical strength (1 s of MPa at best). In addition, we expect further improvements in our HCF tensile strength (and overall mechanical performance) as the technology matures, targeting tensile strengths well beyond 1200 MPa.

Advantageously, the high thermal insulation properties and high strength characteristic of the insulating material 10 disclosed in this document will significantly reduce the amount of structural materials required in the composite vessels, thereby reducing weight, cost, and improving overall efficiency of the system, all of which are major goals of the DOE. Additionally, we observe modulus of the hollow carbon fibers above 150 GPa, which provides excellent stiffness for composite applications. The insulating material 10 may also be used in other applications where insulating properties and light weight are considerations. Examples include a variety of aerospace applications such as hypersonics, where thermal protection systems (TPS) are engineered to shield a spacecraft's interior components from high temperature conditions.

### Experimental

Small initial hollow carbon fiber and solid carbon fiber (T700S) composite specimens (approximately 12×24×2.5 mm) were produced using EPON 828 resin with Epikure W. It was found that the hollow carbon fiber composite offered approximately a 25% reduction in thermal conductivity compared to the solid carbon fiber composite baseline at both 25 and −100° C., at atmospheric pressure. Moreover, the reduction in density of the hollow carbon fiber composite relative to the baseline tracked close to the average filament percent open area, which was approximately 30% (average inner and outer diameters ˜12.5 and 23 micron, respectively). These data suggest that we can expect, at atmospheric pressure, a reduction in thermal conductivity commensurate with the percent open area of the hollow carbon fiber. Based upon these results, for hollow carbon fiber composite having an average filament percent open area of 50%, we can expect to see reductions in thermal conductivity of approximately 50%, in the range of 0.394 and 0.384 W/mK at 25° C. and −100° C., respectively, at atmospheric pressure.

This disclosure may be said to relate to the following items.

1. An insulating material, comprising hollow carbon fibers embedded in a matrix material.

2. The insulating material of item 1, including about 60 wt % to about 90 wt % hollow carbon fiber and about 40 wt % to about 10 wt % matrix material.

3. The insulating material of item 2, wherein the hollow carbon fiber has an average filament open area of between about 20% to about 70%.

4. The insulating material of item 3, wherein the hollow carbon fiber has an average inner diameter of between about 3 microns to about 30 microns and an average outer diameter of between about 5 microns and about 50 microns.

5. The insulating material of item 3, wherein the hollow carbon fiber has an average inner diameter of between about 4.5 microns to about 10 microns and an average outer diameter of between about 7 microns and about 25 microns.

6. The insulating material of item 4, wherein the matrix material is a thermosetting resin.

7. The insulating material of item 6, wherein the thermosetting resin is selected from a group consisting of epoxy, melamine, phenolic, polyester, silicone, urea-based resin and combinations thereof.

8. The insulating material of item 4, wherein the matrix material is a thermoplastic resin.

9. The insulating material of item 8, wherein the thermoplastic resin is selected from a group consisting of acetal, acrylic, cellulose acetate, nylon, polycarbonate, polyethylene, polypropylene, polystyrene based resin and combinations thereof.

10. The insulating material of item 1, wherein the hollow carbon fibers include sealed lumens in vacuum.

11. The insulating material of item 1, wherein the hollow carbon fibers have an average filament open area of at least 30%.

12. The insulating material of item 1, wherein the hollow carbon fibers have an average filament open area of at least 40%.

13. The insulating material of item 1, wherein the hollow carbon fibers have an average filament open area of at least 50%.

14. The insulating material of item 1, wherein the hollow carbon fibers have an average filament open area of at least 60%.

15. The insulating material of item 1, wherein the hollow carbon fibers have an average filament open area of at least 70%.

16. The insulating material of item 1, having a tensile strength of greater than 1,200 MPa and a thermal conductivity, through thickness of the composite, of less than 1 W/mK.

17. The insulating material of item 1, wherein the matrix material is selected from a group consisting of epoxy, melamine, phenolic, polyester, silicone and urea-based resins acetal, acrylic, cellulose acetate, nylon, polycarbonate, polyethylene, polypropylene and polystyrene based resins as well as combinations thereof.

18. An insulating material, comprising hollow carbon fibers embedded in a matrix material wherein the insulating material has a modulus of elasticity of greater than 150 GPa, a tensile strength of greater than 1,200 MPa and a thermal conductivity of less than about 1 W/mK.

19. The insulating material of item 18, wherein the hollow carbon fiber has an average inner diameter of between about 3 microns to about 30 microns and an average outer diameter of between about 5 microns and about 50 microns.

20. A composite tank made from the insulating material set forth in any of items 1-19.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a thermosetting resin”, as used herein, may also refer to, and encompass, a plurality of thermosetting resins.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the insulating materials of this disclosure have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed:

1. An insulating material, comprising hollow carbon fibers embedded in a matrix material.

2. The insulating material of claim 1, including about 60 wt % to about 90 wt % hollow carbon fiber and about 40 wt % to about 10 wt % matrix material.

3. The insulating material of claim 2, wherein the hollow carbon fiber has an average filament open area of between about 20% to about 70%.

4. The insulating material of claim 3, wherein the hollow carbon fiber has an average inner diameter of between about 3 microns to about 30 microns and an average outer diameter of between about 5 microns and about 50 microns.

5. The insulating material of claim 3, wherein the hollow carbon fiber has an average inner diameter of between about 4.5 microns to about 10 microns and an average outer diameter of between about 7 microns and about 25 microns.

6. The insulating material of claim 4, wherein the matrix material is a thermosetting resin.

7. The insulating material of claim 6, wherein the thermosetting resin is selected from a group consisting of epoxy, melamine, phenolic, polyester, silicone, urea-based resin and combinations thereof.

8. The insulating material of claim 4, wherein the matrix material is a thermoplastic resin.

9. The insulating material of claim 8, wherein the thermoplastic resin is selected from a group consisting of acetal, acrylic, cellulose acetate, nylon, polycarbonate, polyethylene, polypropylene, polystyrene based resin and combinations thereof.

10. The insulating material of claim 1, wherein the hollow carbon fibers include sealed lumens in vacuum.

11. The insulating material of claim 1, wherein the hollow carbon fibers have an average filament open area of at least 30%.

12. The insulating material of claim 1, wherein the hollow carbon fibers have an average filament open area of at least 40%.

13. The insulating material of claim 1, wherein the hollow carbon fibers have an average filament open area of at least 50%.

14. The insulating material of claim 1, wherein the hollow carbon fibers have an average filament open area of at least 60%.

15. The insulating material of claim 1, wherein the hollow carbon fibers have an average filament open area of at least 70%.

16. The insulating material of claim 1, having a tensile strength of greater than 1,200 MPa and a thermal conductivity, through thickness of the composite, of less than 1 W/mK.

17. The insulating material of claim 1, wherein the matrix material is selected from a group consisting of epoxy, melamine, phenolic, polyester, silicone and urea-based resins acetal, acrylic, cellulose acetate, nylon, polycarbonate, polyethylene, polypropylene and polystyrene based resins as well as combinations thereof.

18. An insulating material, comprising hollow carbon fibers embedded in a matrix material wherein the insulating material has a modulus of elasticity of greater than 150 GPa, a tensile strength of greater than 1,200 MPa and a thermal conductivity of less than about 1 W/mK.

19. The insulating material of claim 18, wherein the hollow carbon fiber has an average inner diameter of between about 3 microns to about 30 microns and an average outer diameter of between about 5 microns and about 50 microns.

20. A composite tank made from the insulating material set forth in claim 1.
